(19) United States
(12) Patent Application Publication
(10) Pub. No.: US 2015/0088638 A1
(43) Pub. Date: Mar. 26, 2015

(54) SYSTEMS AND METHODS FOR DETERMINING QUALITY OF IDENTIFIERS FOR ATTRIBUTION

(71) Applicant: Tune, Inc., Seattle, WA (US)

(72) Inventor: Niek Sanders, Seattle, WA (US)

(21) Appl. No.: 14/494,460

(22) Filed: Sep. 23, 2014

Related U.S. Application Data
(60) Provisional application No. 61/881,348, filed on Sep. 23, 2013.

(51) Int. Cl. G06Q 30/02; H04L 29/08

(52) U.S. Cl. CPC G06Q 30/0246; H04L 67/1097
USPC 705/14.45

(57) ABSTRACT

Activity on computing devices may be tracked based on identifiers such as IP addresses. However, tracking systems may not be informed of which IP addresses uniquely identify end user computing devices, and which IP addresses are instead shared by multiple end user computing devices. Embodiments of the present disclosure provide systems, methods, and/or computer-readable media that store instructions for assigning quality scores to tracked identifiers, which may then be used to determine which identifiers are useful for tracking purposes and which are not.

### CROSS-REFERENCE TO RELATED APPLICATION

This application claims the benefit of U.S. Provisional Application No. 61/881348, filed Sep. 23, 2013, the entire disclosure of which is hereby incorporated by reference in its entirety for all purposes.

### BACKGROUND

Traditionally, advertisements may be displayed by computing devices to promote products and/or services. A link associated with the advertisement may provide tracking functionality for recording an interaction with the advertisement on the computing device. However, traditional tracking functionality is limited. For instance, the computing device may be identified to the tracking system by a network identifier associated with the computing device, such as an internet protocol (IP) address. Some IP addresses are associated with more than one computing device, and so are not as useful for identifying a given computing device as IP addresses that are associated with only a single computing device. What is desired are techniques for determining which IP addresses are useful as identifiers for tracking activity, and which IP addresses are not as useful.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a tracking server is provided. The tracking server is configured to receive an interaction notification that includes an identifier, a device description, and a timestamp; determine a time bucket for the timestamp; store the device description in an identifier quality data store in association with the identifier and the time bucket; and use data stored in the identifier quality data store to determine a quality score for the identifier, wherein the quality score represents a likelihood that the identifier uniquely identifies an end user computing device during a given time bucket.

In some embodiments, a computer-implemented method is provided. A tracking server receives an interaction notification that includes an identifier, a device description, and a timestamp. The tracking server determines a time bucket for the timestamp, and stores the device description in an identifier quality data store in association with the identifier and the time bucket. The tracking server uses data stored in the identifier quality data store to determine a quality score for the identifier, wherein the quality score represents a likelihood that the identifier uniquely identifies an end user computing device during a given time bucket.

In some embodiments, a nontransitory computer-readable medium is provided. The computer-readable medium has computer-executable instructions stored thereon that, in response to execution by one or more processors of a tracking server, cause the tracking server to perform actions comprising receiving an interaction notification that includes an identifier, a device description, and a timestamp; determining a time bucket for the timestamp; storing the device description in an identifier quality data store in association with the identifier and the time bucket; and using data stored in the identifier quality data store to determine a quality score for the identifier, wherein the quality score represents a likelihood that the identifier uniquely identifies an end user computing device during a given time bucket.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates an exemplary embodiment of a tracking ecosystem according to various aspects of the present disclosure;

FIGS. 2A and 2B are schematic diagrams that illustrate the difficulties in assuming that an IP address can be used to uniquely identify an end user computing device;

FIG. 3 is a block diagram that illustrates an exemplary embodiment of some elements of the tracking system according to various aspects of the present disclosure;

FIGS. 4A and 4B are a flowchart that illustrates an exemplary embodiment of a method of automatically determining a quality of an identifier for uniquely identifying a computing device for tracking purposes, according to various aspects of the present disclosure;

FIGS. 5A-5D are high-level schematic diagrams that illustrate a flow of data through an exemplary embodiment of the tracking system according to various aspects of the present disclosure; and

FIG. 6 is a diagram of hardware and an operating environment in conjunction with which implementations of the one or more computing devices of the ecosystem may be practiced.

### DETAILED DESCRIPTION

### Tracking System Overview

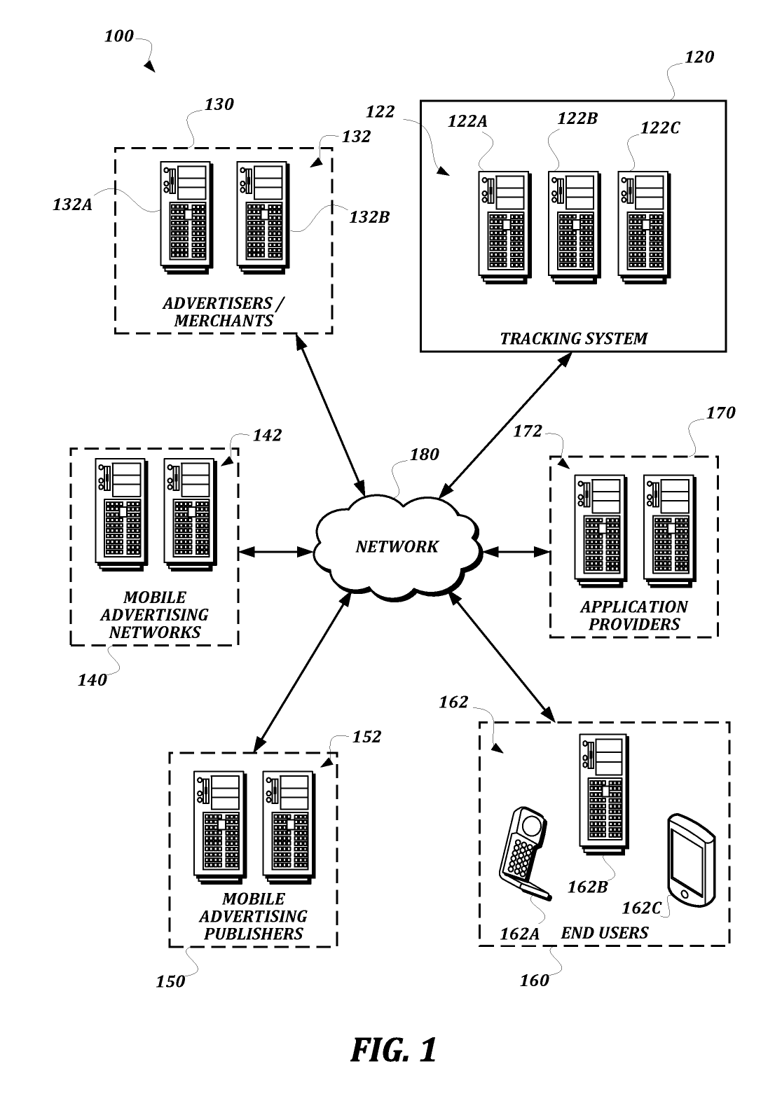

FIG. 1 is a schematic diagram that illustrates an exemplary embodiment of a tracking ecosystem 100 according to various aspects of the present disclosure. The tracking ecosystem 100 may be configured to match advertisement impressions with subsequent activity based on identifiers associated with a computing device on which an advertisement was presented. This matching may allow ad impressions and/or conversions to be recorded and attributed to the appropriate party or parties that provided (e.g., distributed and/or displayed) the advertisements.

As illustrated, the system 100 includes a tracking system 120. The tracking system 120 includes one or more computing devices 122. In the embodiment illustrated, the computing devices 122 include a tracking server 122A, a storage service server 122B, and a management interface server 122C. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A and the management interface server 122C may be combined on a single computing device (not shown). The tracking system 120 is not limited to the use of a particular number of computing devices to implement the functionality of the tracking server 122A, the storage service server 122B, and the management interface server 122C.

The system 100 also includes one or more computing devices 132 operated by one or more Advertisers/Merchants 130, one or more computing devices 142 operated by one or more Mobile Advertising Networks 140, one or more computing devices 152 operated by one or more Mobile Advertising Publishers 150, a plurality of computing devices 162 operated by a plurality of End Users 160, and one or more computing devices 172 operated by one or more Application Providers 170.

As is apparent to those of ordinary skill in the art, in some embodiments, a single entity may function as one of the Advertisers/Merchants 130, one of the Mobile

Advertising Networks 140, and one of the Mobile Advertising Publishers 150, even though they are illustrated in FIG. 1 as separate entities. Such an entity may operate one or more computing devices (not shown) that perform the functions of the computing devices 132, 142, and 152.

The Advertisers/Merchants 130 include companies that wish to advertise products and/or services. The Mobile Advertising Networks 140 include companies that help distribute advertisements for the Advertisers/Merchants 130 for presentation to end users. The Mobile Advertising Networks 140 may provide services to Mobile Advertising Publishers 150 that allow Mobile Advertising Publishers 150 to present advertisements received from the Mobile Advertising Networks 140 to end users. Non-limiting examples of such companies include Google (the AdWords platform), Apple (the iAd platform), Millennial Media, Tapjoy, InMobi, Advertising.com, AdColony, Jumptap, Nexage, and the like.

The Mobile Advertising Publishers 150 include providers of web sites and mobile applications that display advertisements. Non-limiting examples of such companies include Pandora, Spotify, Facebook, Twitter, Bittorrent.com, The Weather Channel, and any other application or website provider that displays advertisements. In some embodiments, a company may act as both a Mobile Advertising Network 140 and a Mobile Advertising Publisher 150.

The End Users 160 include people who use the computing devices 162 and view advertisements, such as those created by the Advertisers/Merchants 130, distributed by the Mobile Advertising Networks 140, and/or displayed by the Mobile Advertising Publishers 150. The End Users 160 may also use the computing devices 162 to purchase, download, install, and/or interact with applications provided by the Application Providers 170.

The Application Providers 170 include companies that provide installable applications to the End Users 160. Non-limiting examples of such companies include “app stores,” such as iTunes App Store, Google Play, Amazon Appstore, and the like. The one or more computing devices 172 may be configured to generate a download page (not shown) from which an application may be purchased, downloaded, and/or installed. The download page may be implemented as a webpage. The installable applications may include advertising functionality configured to present advertisements to the end user and to report tracking information to be consumed by the tracking system 120.

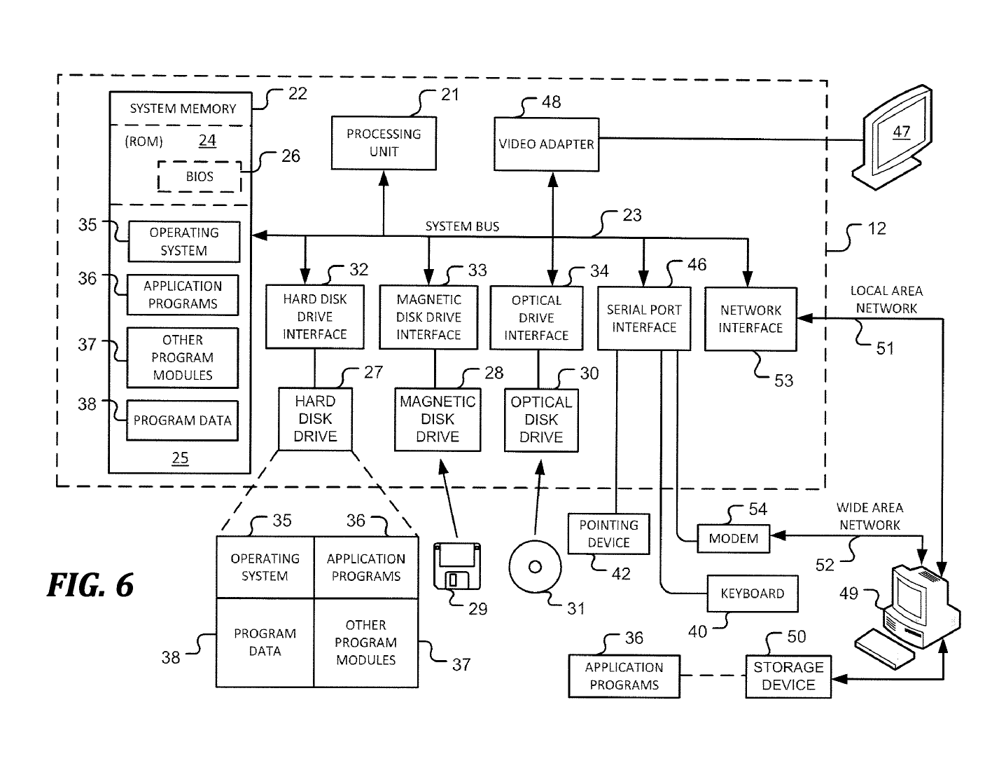

The computing devices 122, 132, 142, 152, 162, and 172 are connected to one another by a network 180 (e.g., the Internet). Each of the computing devices 122, 132, 142, 152, 162, and 172 may be implemented using a computing device similar to the computing device 12 illustrated in FIG. 6 and described below. By way of non-limiting examples, the computing devices 162 have been illustrated as including a cellular telephone 162A, a personal computer 162B (e.g., a desktop computer), and a tablet computer 162C. Each of the computing devices 162 may be configured to implement an advertisement displaying application.

### Determining Quality of an Identifier for Uniquely Identifying a Computing Device

The tracking system 120 introduced above is useful for tracking the activity of end user computing devices 160 and attributing actions performed thereon to advertisements presented by ad providers. However, in order to accurately associate activity on a given end user computing device 162 with a given advertisement, the tracking system 120 should determine an identifier that can be reliably used to uniquely identify the end user computing device 162. One example of an identifier that could be used in this manner is a network address, such as an internet protocol (IP) address, that is associated with the end user computing device 162. Unfortunately, some IP addresses cannot be used to uniquely identify an end user computing device 162, because more than one end user computing device 162 may appear to be associated with a single IP address.

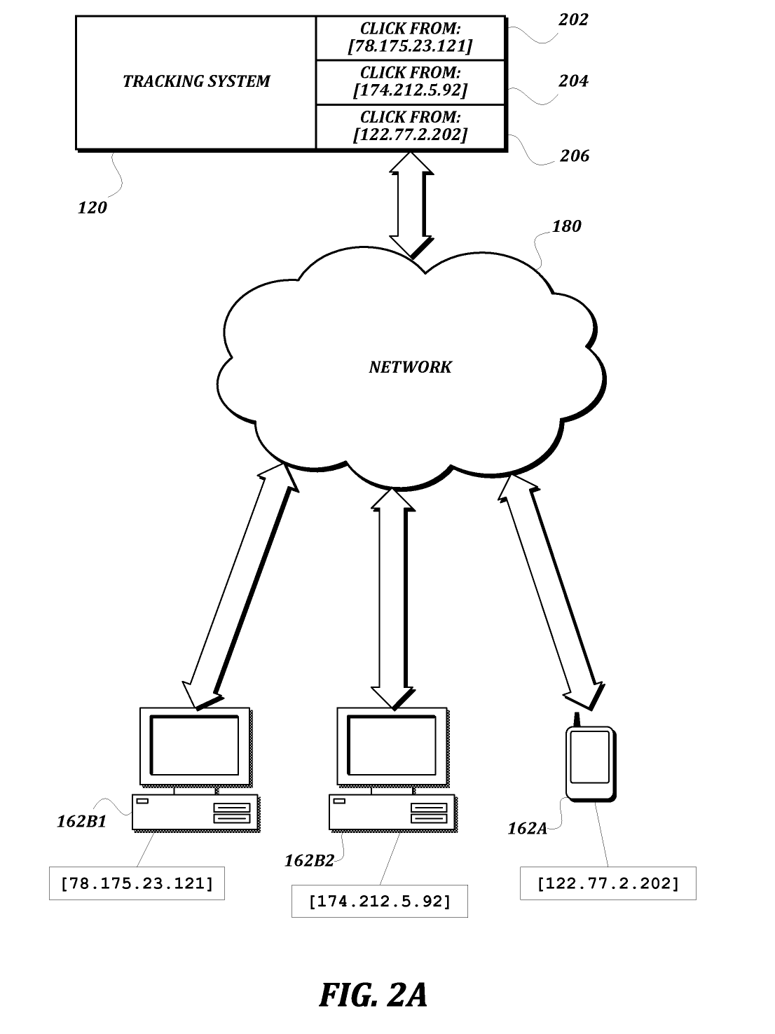

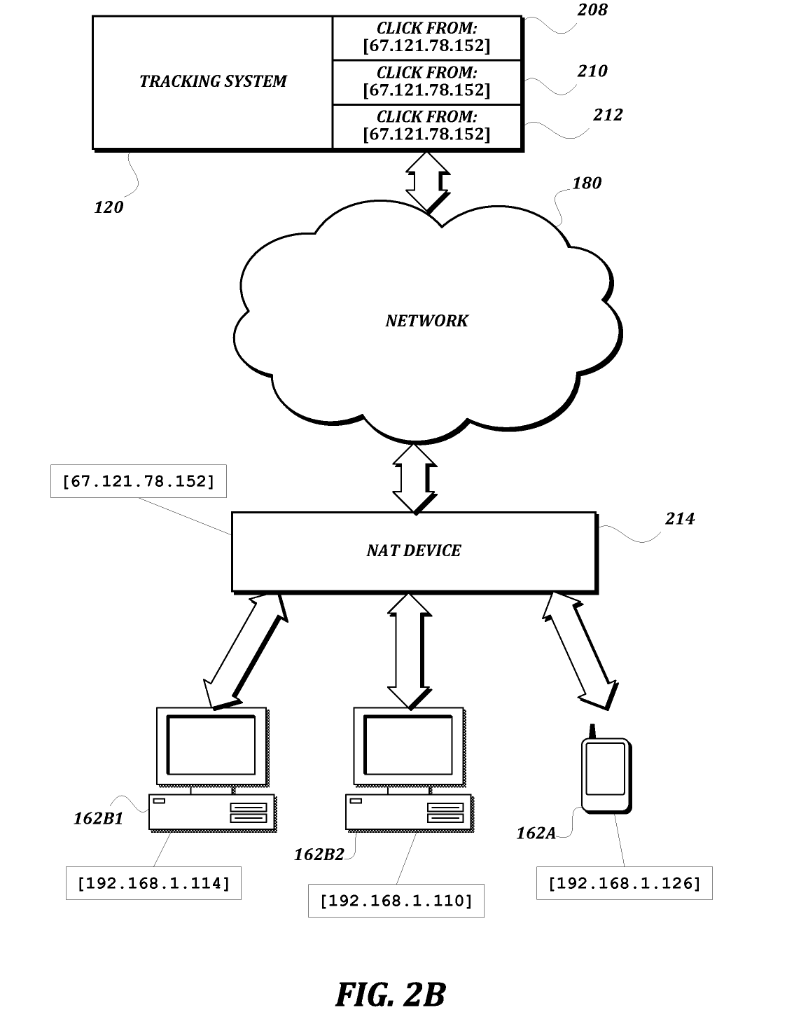

FIGS. 2A and 2B are schematic diagrams that illustrate the difficulties in assuming that an IP address can be used to uniquely identify an end user computing device 162. In FIG. 2A, a first computing device 162B1, a second computing device 162B2, and a third computing device 162A are all connected to the network 180, and each is associated with a public IP address that can be used to communicate with the respective computing device. When activity such as a click is monitored by the tracking system 120 for these computing devices, a first click notification 202 will include the public IP address assigned to the first computing device 162B1, a second click notification 204 will include the public IP address assigned to the second computing device 162B2, and the third click notification 206 will include the public IP address assigned to the third computing device 162A.

FIG. 2B illustrates the problem that arises when the computing devices have not been assigned public IP addresses. In FIG. 2B, the first computing device 162B1, the second computing device 162B2, and the third computing device 162A are connected to the network via a network address translation (NAT) device 214. The NAT device 214 has a public IP address, but provides private IP addresses to each of the computing devices 162B1, 162B2, 162A so that they may share the single public IP address. This network configuration is in common use, including in private homes that share a wireless router or cable modem to connect to the Internet, in wireless data communication with smartphones, and in other situations. As illustrated, even though the tracking system 120 has monitored a click from each of the computing devices 162B1, 162B2, 162A, the first click notification 208, the second click notification 210, and the third click notification 212 all include the public IP address of the NAT device 214.

If IP addresses were being used by the tracking system 120 as identifiers of end user computing devices 162, each of the three click notifications 208, 210, 212 would be determined to come from a single end user computing device, which is not accurate and may skew the tracking results to the point where they are no longer useful.

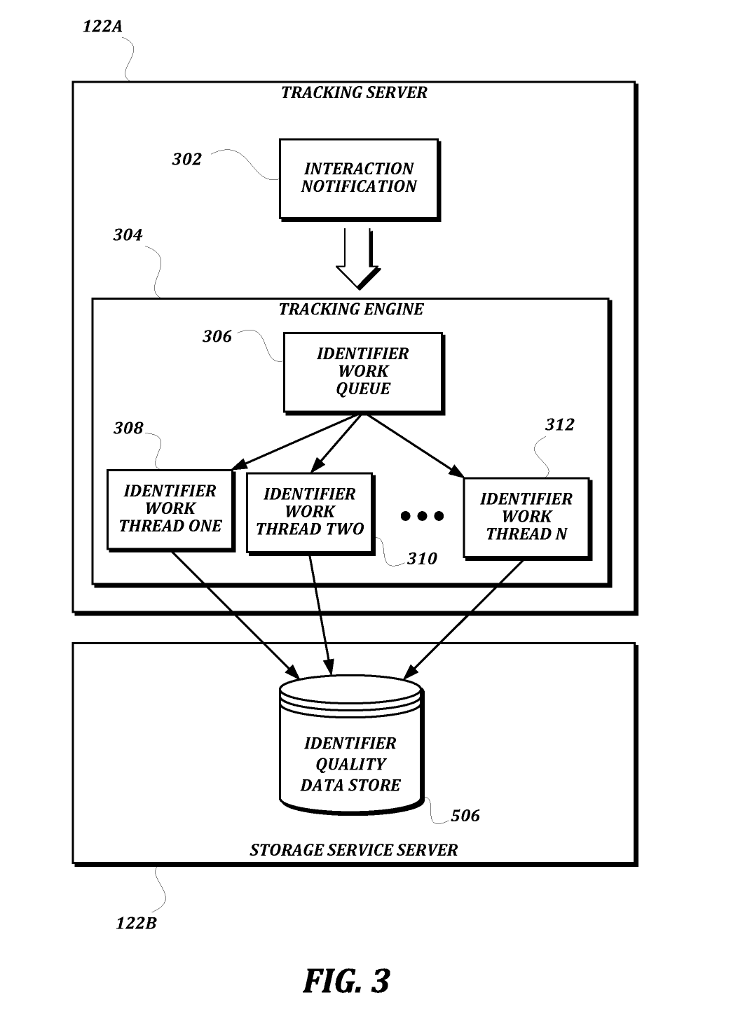

FIG. 3 is a block diagram that illustrates an exemplary embodiment of some elements of the tracking system 120 according to various aspects of the present disclosure. As illustrated, the tracking server 122A is configured to provide a tracking engine 304. In general, the term “engine” as used herein refers to logic embodied in hardware or software instructions, which can be written in a programming language, such as C, C++, Objective-C, COBOL, JAVA™, PHP, Perl, HTML, CSS, JavaScript, Ruby, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines or applications, or can be divided into sub-engines. The engines can be stored in any type of computer-readable medium or computer storage device and be stored on and executed by one or more general purpose computers, thus creating a special purpose computer configured to provide the engine.

The tracking engine 304 is configured to create or receive the interaction notification 302 to be processed, and to extract identifier information therefrom for processing. The interaction notification 302 represents a tracked interaction such as an ad impression, a click on an advertisement, and/or the like, and includes an identifier associated with an end user computing device 162 that may or may not uniquely identify the end user computing device 162, as well as a timestamp and a device descriptor. In some embodiments, the identifier may be a network address such as an IP address, a MAC address, and/or the like. The timestamp indicates a time and/or date at which the interaction occurred, and may be provided in any suitable format. In some embodiments, the timestamp may be in a human-readable format (such as “MM/DD/YYYY HH:MM:SS” or the like), while in other embodiments, the timestamp may be converted to a Unix epoch format (for example, instead of Sep. 4, 2013 at 3:31:02 PM being represented as “09/04/2013 15:31:02” it may instead be represented as the Unix epoch format “1378308662”) in order to facilitate processing. The device descriptor is additional information that describes aspects of the end user computing device 162 that may provide additional information that helps distinguish when multiple devices are sharing an identifier. One example of a device descriptor is a user agent string, though other information may be used instead of or in addition to a user agent string as a device descriptor.

The identifier information (including the identifier, the timestamp, and the device descriptor) may be provided to an identifier work queue 306 to be processed by one or more worker threads 308, 310, 312. Because the identifier uniqueness information is applied during a given time bucket, the impact of out-of-order processing for incoming interaction notifications 302 is minimal. In some embodiments, the tracking server 122A strives to process the information in a given time bucket before a later action associated with the interaction notification occurs. For example, if the interaction notification 302 represents a click on an advertisement, the information associated with that click should be processed to determine the uniqueness of the identifier before a purchase of an item or service associated with the advertisement is completed. The use of multiple worker threads may help ensure that such timing can be achieved. One of ordinary skill in the art will recognize that though multiple worker threads are illustrated, in some embodiments a single thread may be used, and in some embodiments some other suitable parallel processing technique (such as the use of multiple processes instead of or in addition to the use of multiple threads) may be used. In some embodiments, once all conversions or other actions during a given time bucket have been processed, the identifier quality data for the time bucket may be erased from the identifier quality data store 506.

As illustrated, the storage service server 122B is configured to provide an identifier quality data store 506. As understood by one of ordinary skill in the art, a “data store” as described herein may be any suitable device configured to store data for access by a computing device. In some embodiments, the data store may be a key-value store that represents data as a collection of key-value pairs, such that each key appears at most once in the collection and is usable to uniquely identify a value in the data store. Examples of key-value stores include Not Only SQL (NoSQL) data stores such as Dynamo data stores, the DynamoDB system provided by Amazon Web Services, Inc., and/or the like. These key-value stores are capable of distributed processing and therefore allow fast and reliable storage of data rows locatable by unique keys. Other examples of a data store include a highly reliable, high-speed relational database management system (DBMS) executing on one or more computing devices and accessible over a high-speed network. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

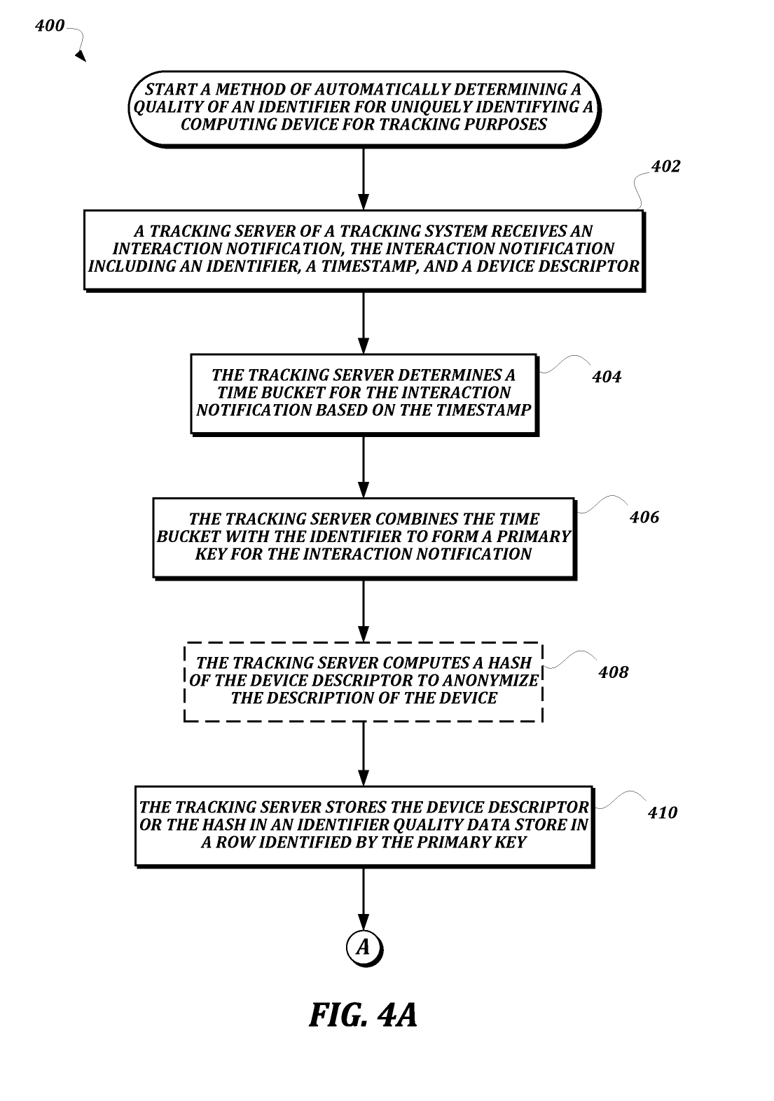

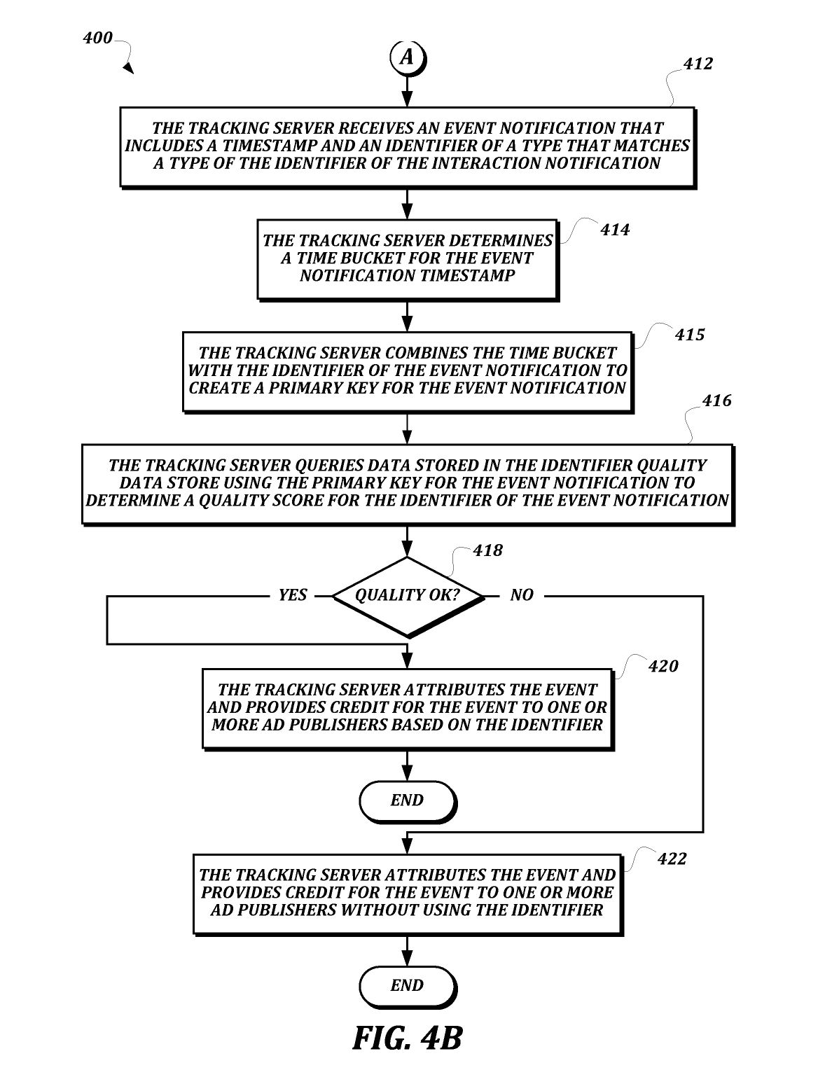

FIGS. 4A and 4B are a flowchart that illustrates an exemplary embodiment of a method 400 of automatically determining a quality of an identifier for uniquely identifying a computing device for tracking purposes, according to various aspects of the present disclosure. From a start block, the method 400 proceeds to block 402, where a tracking server 122 of a tracking system 120 receives an interaction notification, the interaction notification including an identifier, a timestamp, and a device descriptor.

At block 404, the tracking server 122 determines a time bucket for the interaction notification based on the timestamp. Each time bucket is a predetermined period of time during which identifiers will be compared. For example, one predetermined period of time would be ten minutes starting at the top of an hour. Accordingly, one time bucket could be from noon to 12:10 on Jan. 1, 2014, while the next time bucket would be from 12:10 to 12:20 on Jan. 1, 2014. Ten minutes is an example of an appropriate size for a time bucket, though in other embodiments, any other appropriate size may be used. As IP addresses assigned by DHCP may change periodically, the time bucket size may be configured to a time period for which it can generally be assumed that an IP address for a given computing device is stable.

Next, at block 406, the tracking server 122 combines the time bucket with the identifier to form a primary key for the interaction notification. In some embodiments, the tracking server 122 may use a simplified representation of the time bucket, for example, an indicator of a beginning or end of the time bucket period. That is, for a ten-minute time bucket that goes from 12:10 PM on Jan. 1, 2014 to 12:20 PM on Jan. 1, 2014, the tracking server 122 may combine the string “Jan. 1, 2014 12:20:00” with the identifier. In some embodiments, the combination performed by the tracking server 122 may be a concatenation of the representation of the time bucket with the identifier. In some embodiments, the combination performed by the tracking server 122 may concatenate the two values and separate them with a delimiter. In some embodiments, the identifier may be hashed in order to protect the privacy of the tracked end user computing device 162 using a suitable hashing technique such as MD5, SHAT, and/or the like.

At optional block 408, the tracking server 122 computes a hash of the device descriptor to anonymize the description of the device associated with the interaction notification. Any suitable hashing technique, such as MD5, SHAT, and/or the like, may be used. In some embodiments, it is not important to for the tracking server 122 to analyze the meaning of the device description beyond being able to detect duplicates, so passing the device descriptor through a hashing function can help protect privacy without impacting utility. Also, the use of a hashing function might make comparisons between hashed device descriptors quicker, because a string comparison wouldn't have to be performed to determine if two hashed device descriptors are duplicates of each other. The actions described with respect to optional block 408 are optional because the plaintext version of the device descriptor might be used instead of the hashed version.

The method 400 then proceeds to block 410, where the tracking server 122 stores the device descriptor (or the hash instead, if the hash was computed) in an identifier quality data store 506 in a row identified by the primary key. In some embodiments, the identifier quality data store 506 may provide string set operations that allow the device descriptor (or hash value) to be added to a list of device descriptors associated with the primary key using a single call to the identifier quality data store 506. In some embodiments, the identifier quality data store 506 may have a limit for an amount of data that can be stored in a given row. In such embodiments, an error may be returned by the identifier quality data store 506 if the row identified by the primary key is already full. In such cases, the error may be ignored, since it would indicate that a large number of device descriptors are already associated with the primary key, and so the addition of another device descriptor would not be likely to lower the quality score for the primary key by an appreciable amount. The method 400 then proceeds to a continuation terminal (“terminal A”).

From terminal A (FIG. 4B), the method 400 proceeds to block 412, where the tracking server 122 receives an event notification that includes a timestamp and an identifier of a type that matches a type of the identifier of the interaction notification. In some embodiments, the event notification represents an event to be matched with a previously tracked interaction. For example, the previously tracked interaction may be an ad impression or a click on an advertisement, and the event to be matched could be an installation of the advertised application. As another example, the previously tracked interaction may be an ad impression, and the event to be matched could be a click on the advertisement. One of ordinary skill in the art will recognize that a matching type of identifier will be a comparable identifier, such as both being IP address, both being MAC addresses, and/or the like.

Next, at block 414, the tracking server 122 determines a time bucket for the event notification timestamp. The technique for determining the time bucket for the event notification timestamp matches the technique for determining the time bucket discussed above with respect to block 404. At block 415, the tracking server 122 combines the time bucket with the identifier of the event notification to create a primary key for the event notification. Again, the technique for combining the time bucket with the identifier matches the technique discussed above with respect to creating the primary key for the interaction notification, such that if the time buckets match and the identifiers match, the primary keys will also match.

At block 416, the tracking server 122 queries data stored in the identifier quality data store 506 using the primary key for the event notification to determine a quality score for the identifier of the event notification. In some embodiments, the tracking server 122 will receive the data stored in the identifier quality data store 506 under the primary key, and may then count the number of device descriptors that were stored using the primary key. In some embodiments, the tracking server 122 may submit a query to the identifier quality data store 506 that requests a count for the number of device descriptors stored using the primary key.

Once the tracking server 122 has obtained the count of device descriptors stored using the primary key, the tracking server 122 may use this count to determine a quality score. In some embodiments, the raw count of device descriptors may be used as the quality score. In some embodiments, the raw count of device descriptors may be normalized and/or scaled to produce the quality score. For example, the inverse of the count may be calculated in order generate a quality score between zero and one.

Next, at decision block 418, a test is performed to determine whether the quality score meets a predetermined threshold. In some embodiments, the threshold may be set strictly, such that any indication in the quality score that the identifier is shared by more than one computing device would cause the threshold to not be met. In some embodiments, the threshold may be set less strictly, to indicate that some number of shared users will be tolerated. For example, a small number of records associated with a given IP address may indicate the presence of a NAT device in a private home, and tracking activity for the household as a whole may be useful for advertisers. Accordingly, in this example, the predetermined threshold may be set to a value that allows some small number of records greater than one to meet the predetermined threshold.

If the quality score meets the predetermined threshold, then the result of the test at decision block 418 is YES, and the method 400 proceeds to block 420, where the tracking server 122 attributes the event and provides credit for the event to one or more ad publishers based on the identifier. The credit may include any suitable form of credit, including but not limited to a monetary reward, an inclusion of a record in a report, and/or the like. Further discussion of providing credit to one or more ad publishers is provided in commonly owned, co-pending U.S. patent application Ser. No. 14/304757, filed Jun. 13, 2014, the entire disclosure of which is hereby incorporated by reference herein for all purposes. The method 400 then proceeds to an end block and terminates.

Otherwise, if the quality score does not meet the predetermined threshold, then the result of the test at decision block 418 is NO, and the method 400 proceeds to block 422, where the tracking server 122 attributes the event and provides credit for the event to one or more ad publishers without using the identifier. In some embodiments, not using the identifier may include leaving the identifier out of a fingerprint calculation that uses multiple sources of information about the computing device to attempt to identify the device. In some embodiments, if ignoring the identifier due to the quality score results in the inability to match the event to any interaction, credit may not be provided for the event to any ad publisher. The method 400 then proceeds to an end block and terminates.

The method 400 illustrated and discussed above describes an embodiment wherein the quality score is used to make a decision whether or not to use the identifier. However, in some embodiments, if the quality score is low it may be used to discount an amount of credit provided to the ad provider instead of not using the identifier for matching at all. Also, in some embodiments, information from other sources may be used while determining the quality score. For example, the tracking server 122A may have access to data sources that list IP addresses that are known to be assigned to NAT devices or other shared internet gateways, and may adjust the quality score accordingly.

While embodiments are discussed above that use IP addresses (specifically, IPv4 addresses) as the identifiers, in some embodiments other identifiers could be used. For example, IPv6 addresses or MAC addresses could be used. As another example, discretized location information (such as latitude and longitude information broken down into buckets) obtained from the end user computing device 162 could be used instead of a network identifier, and the method 400 would determine whether the location can be used as a proxy for identifying the computing device 162 (instead of using a network address).

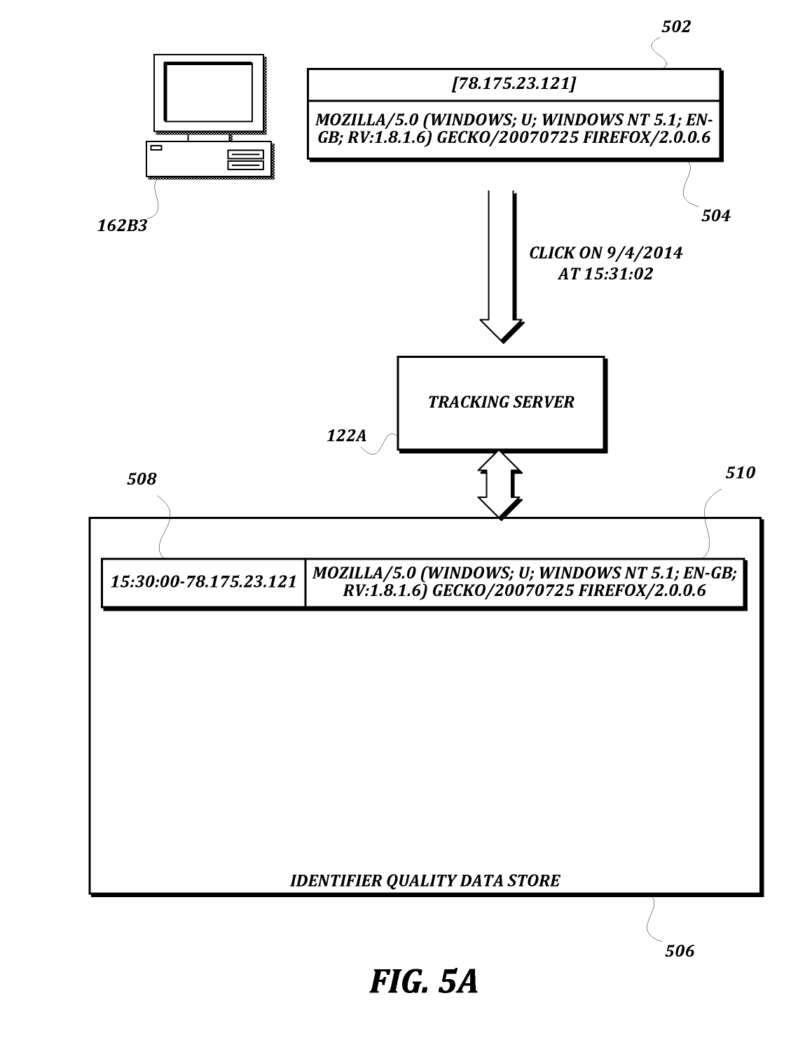

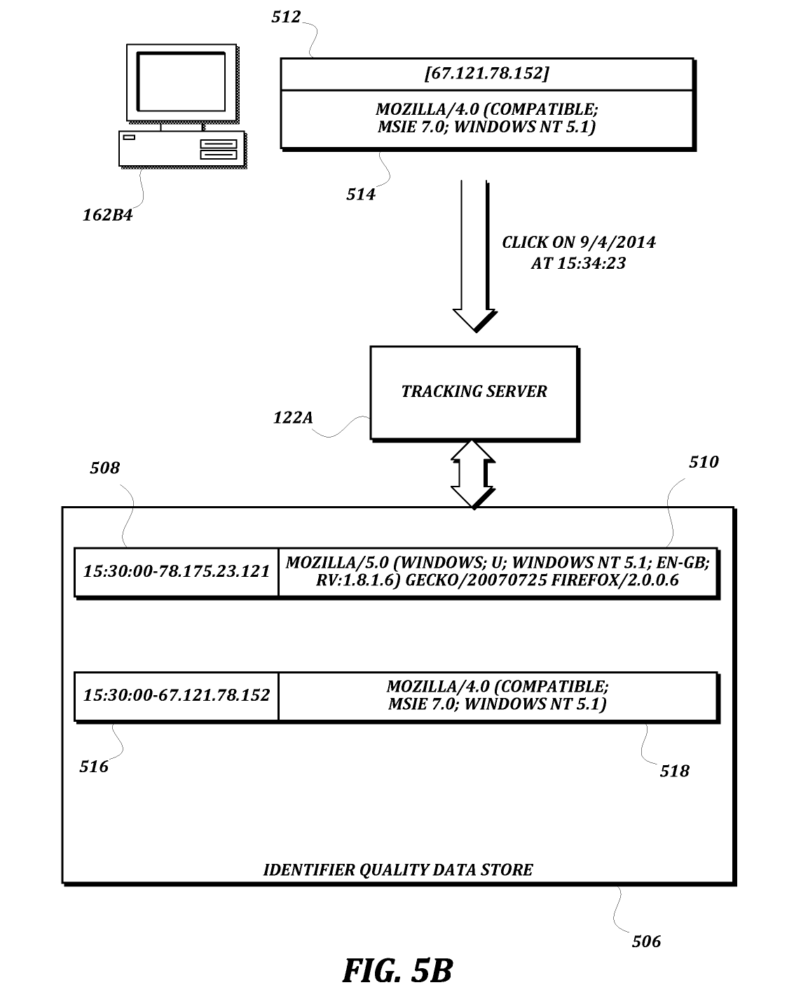

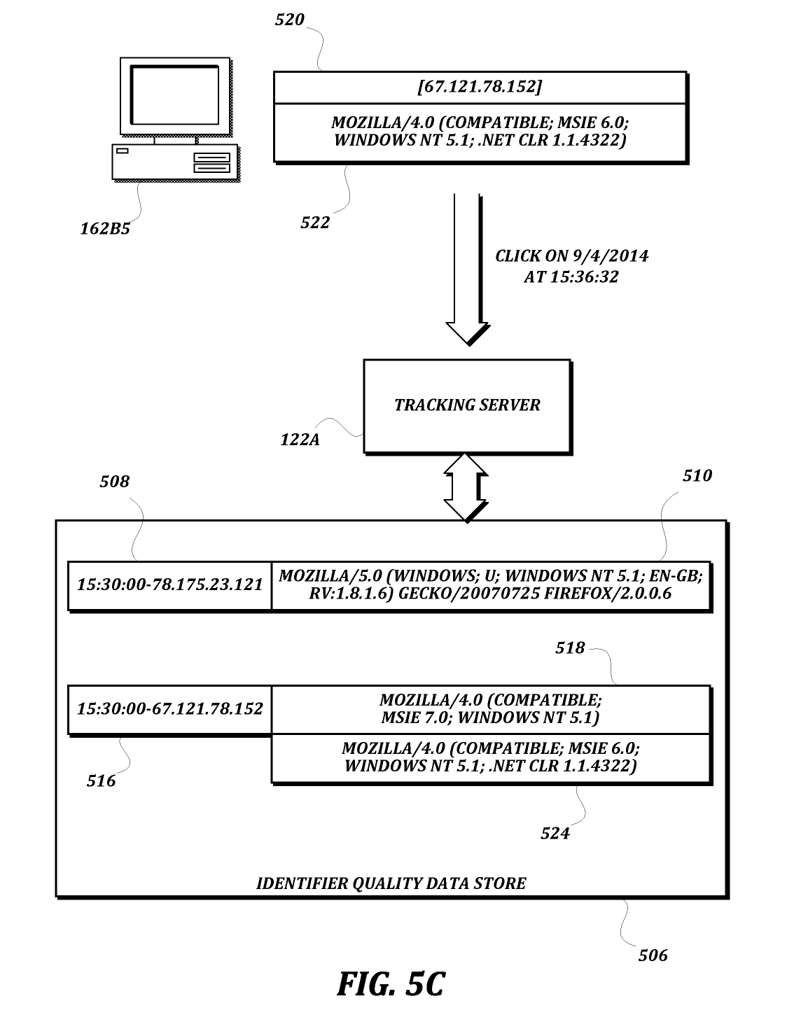

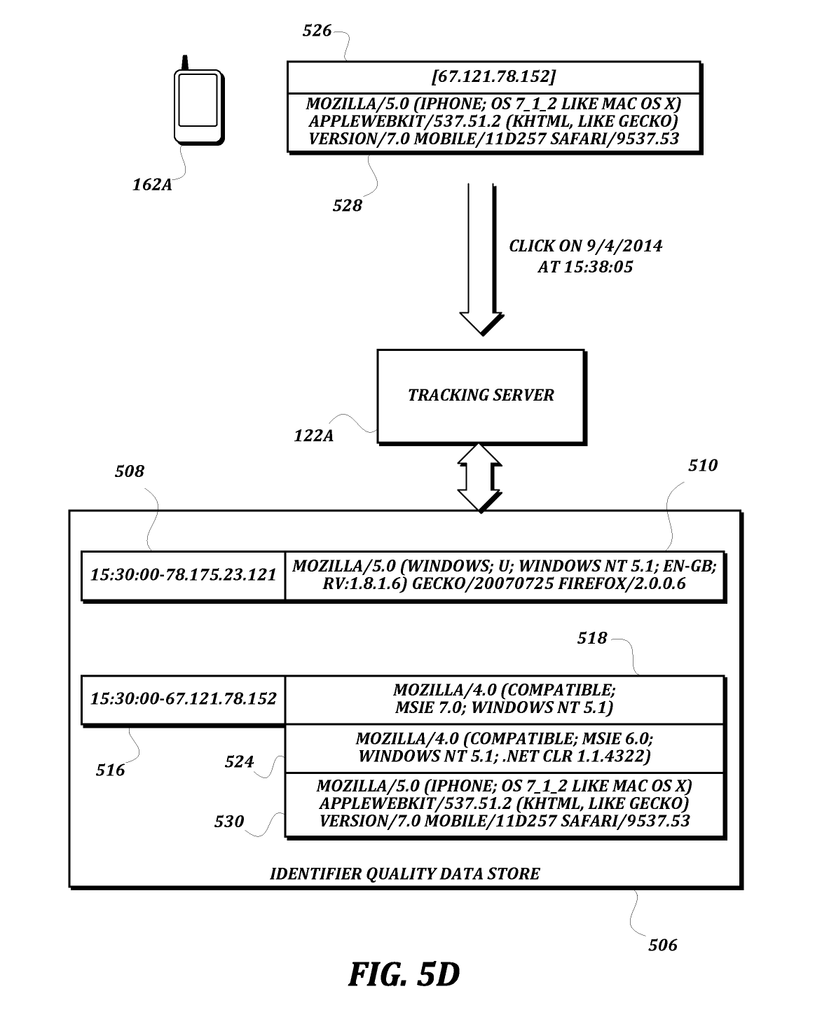

FIGS. 5A-5D are high-level schematic diagrams that illustrate a flow of data through an exemplary embodiment of the tracking system 120 according to various aspects of the present disclosure. These drawings help illustrate an example of how data may be processed and stored during the method 400 described above.

FIG. 5A illustrates a click that is tracked from a first computing device 162B3 from a public IP address. The first computing device 162B3 is associated with an IP address 502 to be analyzed for quality as an identifier and a user agent string 504 that can be used as a device descriptor. The tracking server 122A receives a click notification with a timestamp of Sep. 4, 2014 at 15:31:02. In the illustrated embodiment, the tracking server 122A is configured to use a time bucket interval of ten minutes starting at the top of the hour, and so the time bucket for the click notification is determined to be from Sep. 4, 2014 at 15:30:00 to Sep. 4, 2014 at 15:40:00. The tracking server 122A is configured to create a primary key by concatenating the time portion of the start of the time bucket with the identifier, and separating the two with a hyphen. The primary key 508 is then used to store the device descriptor 510 in the identifier quality data store 506.

FIG. 5B illustrates a click that is tracked from a second computing device 162B4 from an IP address shared by multiple computing devices. The click notification again includes an IP address 512 and a user agent string 514, as well as a timestamp that falls within the time bucket from Sep. 4, 2014, at 15:30:00 to Sep. 4, 2014, at 15:40:00. Accordingly, the tracking server 122A adds a row to the identifier quality data store 506 using the primary key 516, and stores the device descriptor 518 in the new row.

FIG. 5C illustrates a click that is tracked from a third computing device 162B5 that shares the same IP address as the second computing device 162B4.

The click notification includes an IP address 520 that matches the IP address 512 used by the second computing device 162B4 and a timestamp within the matching time bucket, but the user agent string 522 is different. Accordingly, the tracking server 122A creates a primary key for the click notification that matches the primary key 516 created for the second computing device 162B4. The user agent string 524 is then added to the existing row in the identifier quality data store 506 identified by the primary key 516.

FIG. 5D illustrates another click that is tracked from a fourth computing device 162A that shares the same IP address as the second computing device 162B4 and the third computing device 162B5. The IP address 526 of the click notification is again the same, and the user agent string 528 is different. Because the time bucket for the click notification again matches the Sep. 4, 2014 at 15:30:00 time bucket, the tracking server 122A creates another matching primary key 516, and adds the user agent string 530 to the row identified by the primary key 516 in the identifier quality data store 506.

At this point, the tracking server 122A can use the data stored in the identifier quality data store 506 to determine a quality of the IP addresses during the time bucket. The first IP address 508 during the time bucket is associated with only a single device descriptor 510. Accordingly, the tracking server 122A will calculate a high quality score for the IP address 508 during the time bucket to indicate a high likelihood that the IP address 508 during the time bucket uniquely identifies a computing device. Meanwhile, the second IP address 516 during the time bucket is associated with three device descriptors 518, 524, 530. Accordingly, the tracking server 122A will calculate a low quality score for the IP address 516 during the time bucket to indicate a low likelihood that the IP address 516 during the time bucket uniquely identifies a computing device.

### Computing Device

FIG. 6 is a diagram of hardware and an operating environment in conjunction with which implementations of the one or more computing devices of the ecosystem 100 may be practiced. The description of FIG. 6 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, smartphones, network-connected tablet computers, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 6 includes a general-purpose computing device in the form of the computing device 12. Each of the computing devices of FIG. 1 (including the computing devices 122, 132, 142, 152, 162, and 172) may be substantially similar or identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface. The user interface is configured to display portions of the management interface 123 to appropriate users.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 6 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 400 illustrated in FIGS. 4A-4B) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims. the embodiments of the invention in which an exclusive property or privilege is claimed are defined as follows:

1. A tracking server configured to:
receive an interaction notification that includes an identifier, a device description, and a timestamp;
determine a time bucket for the timestamp;
store the device description in an identifier quality data store in association with the identifier and the time bucket; and
use data stored in the identifier quality data store to determine a quality score for the identifier, wherein the quality score represents a likelihood that the identifier uniquely identifies an end user computing device during a given time bucket.

2. The tracking server of claim 1, wherein the tracking server is further configured to:
attribute a tracked action to an ad provider based on the identifier in response to determining that the quality score satisfies a predetermined threshold; and
attribute the tracked action to an ad provider without using the identifier in response to determining that the quality score does not satisfy the predetermined threshold.

3. The tracking server of claim 2, wherein attributing the tracked action includes providing a reward to the ad provider to which the action is attributed.

4. The tracking server of claim 1, wherein the identifier quality data store is a key-value data store.

5. The tracking server of claim 4, wherein the identifier quality data store is a Not Only SQL (NoSQL) data store.

6. The tracking server of claim 4, wherein storing the device description in an identifier quality data store includes combining a representation of the time bucket with the identifier to create a primary key.

7. The tracking server of claim 6, wherein storing the device description in an identifier quality data store further includes:
calculating a hash value based on the device description; and
storing the hash value in the identifier quality data store at a location identified by the primary key.

8. The tracking server of claim 1, wherein the device description includes a user agent string.

9. A computer-implemented method, comprising:
receiving, by a tracking server, an interaction notification that includes an identifier, a device description, and a timestamp;
determining, by the tracking server, a time bucket for the timestamp;
storing, by the tracking server, the device description in an identifier quality data store in association with the identifier and the time bucket; and
using, by the tracking server, data stored in the identifier quality data store to determine a quality score for the identifier, wherein the quality score represents a likelihood that the identifier uniquely identifies an end user computing device during a given time bucket.

10. The method of claim 9, further comprising:
attributing a tracked action to an ad provider based on the identifier in response to determining that the quality score satisfies a predetermined threshold; and
attributing the tracked action to an ad provider without using the identifier in response to determining that the quality score does not satisfy the predetermined threshold.

11. The method of claim 10, wherein attributing the tracked action includes providing a reward to the ad provider to which the action is attributed.

12. The method of claim 9, wherein the identifier quality data store is a key-value data store.

13. The method of claim 12, wherein the identifier quality data store is a Not Only SQL (NoSQL) data store.

14. The method of claim 12, wherein storing the device description in an identifier quality data store includes combining a representation of the time bucket with the identifier to create a primary key.

15. The method of claim 14, wherein storing the device description in an identifier quality data store further includes:
calculating a hash value based on the device description; and
storing the hash value in the identifier quality data store at a location identified by the primary key.

16. The method of claim 9, wherein the device description includes a user agent string.

17. A nontransitory computer-readable medium having computer-executable instructions stored thereon that, in response to execution by one or more processors of a tracking server, cause the tracking server to perform actions comprising:
receiving, by the tracking server, an interaction notification that includes an identifier, a device description, and a timestamp;
determining, by the tracking server, a time bucket for the timestamp;
storing, by the tracking server, the device description in an identifier quality data store in association with the identifier and the time bucket; and
using, by the tracking server, data stored in the identifier quality data store to determine a quality score for the identifier, wherein the quality score represents a likelihood that the identifier uniquely identifies an end user computing device during a given time bucket.

18. The computer-readable medium of claim 17, wherein the actions further comprise:
attributing a tracked action to an ad provider based on the identifier in response to determining that the quality score satisfies a predetermined threshold; and
attributing the tracked action to an ad provider without using the identifier in response to determining that the quality score does not satisfy the predetermined threshold.

19. The computer-readable medium of claim 17, wherein the identifier quality data store is a key-value data store.

20. The computer-readable medium of claim 19, wherein storing the device description in an identifier quality data store includes combining a representation of the time bucket with the identifier to create a primary key.
